(19) United States
(12) Patent Application Publication
(10) Pub. No.: US 2026/0062873 A1
(43) Pub. Date: Mar. 5, 2026

(54) SYSTEMS AND PROCESSES FOR FINISHING A SURFACE UTILIZING AN UNMANNED AERIAL VEHICLE

(71) Applicant: Arthur Jump, JR., Pittston, PA (US)

(72) Inventor: Arthur Jump, JR., Pittston, PA (US)

(21) Appl. No.: 18/824,626

(22) Filed: Sep. 4, 2024

(51) Int. Cl. E01C 19/40; B64U 10/13; B64U 20/80; B64U 101/25; E01C 23/08; E01C 23/16; E04F 21/24; G05D 1/672; G05D 105/05; G05D 109/25

(52) U.S. Cl. CPC E01C 19/40; B64U 10/13; B64U 20/80; E01C 23/08; E04F 21/242; E04F 21/245; G05D 1/672; B64U 2101/25; E01C 23/16; G05D 2105/05; G05D 2109/254

(57) ABSTRACT

One method for finishing a surface includes utilizing a hovering surface finisher with a plurality of attachments and finishers coupled thereto. The surface finisher images a grid on an unfinished surface via a camera and a GPS tracks the location of the surface relative to the surface finisher. A user may program specified parameters, including height and angle above the surface, and speed and time at which the surface finisher flies across the grid to finish the surface. The system operating this process may include a connector that attaches the finisher to the surface finisher and sensors for determining the locational parameters. Utilizing the precise locational information from the sensors, the surface finisher may create various textures on the surface that increase the surface's longevity and safety by reducing slip and fall injuries.

### BACKGROUND OF THE INVENTION

The present invention is directed to systems and processes for finishing a surface utilizing an Unmanned Aerial Vehicle (“UAV”). More specifically, the systems and processes disclosed herein utilize a navigation guided UAV to image, map, and finish a surface.

UAVs or drones are aircrafts without any human pilot, crew, or passengers on board. UAVs were originally developed through the twentieth century for military missions too dull, dirty, or dangerous for humans. By the twenty-first century, drones have become essential assets to most militaries. As wireless communication technologies improved and costs fell, drone use has expanded to non-military applications, such as aerial photography, agriculture, environmental monitoring, policing and surveillance, product deliveries, entertainment, and even drone racing.

Yet, certain industries have been reluctant to implement automated technological processes because of industry-specific experiences and skills. Specifically, much automated technology has not readily adapted to the construction industry, which employs highly specialized and skilled laborers. One such sub-set is the concrete industry, where highly experienced and skilled craftsmen pour, lay, and finish concrete surfaces.

Concrete finishing is the process of creating a smooth, level surface of freshly poured concrete. The finishing process is critical to the overall appearance and durability of the concrete, and typically involves several steps. The first step is to level the concrete surface using a straight board or screed by dragging the screed across the surface of the wet concrete, thereby removing any excess concrete and filling in low spots. After screeding, a tool typically called a float is used to smooth the surface of the concrete so it is level and consistent. An edging tool is then used to create a defined edge along the surface perimeter, preventing chipping or cracking over time. Once the concrete has been floated and usually edged, a broom is used to create texture. If a floor is desired, then the final finishing stage involves smoothing the surface of the concrete with a trowel or power float to create a smooth level finish and remove any remaining imperfections.

Concrete finishing is a challenging and labor-intensive process that is critical to the long-term durability and performance of the concrete. In general, the process of finishing exterior concrete has not changed much over time, with manual labor being the most common finishing method, even in the twenty-first century. For example, skilled laborers still typically manually finish freshly poured concrete and other surfaces with floats, trowels and brooms. Beyond concrete finishing, similar processes are employed to finish other surfaces, including cement, stucco, asphalt, etc. Yet, these processes still involve expensive manual labor, lack precision, and are subject to human error.

Still, a variety of labor-intensive processes performed by UAVs are known in the art. For example, U.S. Pat. Nos. 10,011,352; 11,167,847; and U.S. Pat. No. 11,235,890 to Dahlstrom, the contents of each of which are incorporated by reference in their entireties, disclose an aerial operations system for performing various tasks, such as painting. The aerial vehicle is capable of vertically taking off and landing, hovering, and maneuvering near walls and other structures. The aerial vehicle disclosed by Dahlstrom also includes detachable arms for creating paint effects, such as stenciling, a stipple effect via a stipple brush, a rag wipe, or a stiff bristle broom run through the paint to create lines. But, Dahlstrom is completely silent with respect to finishing a surface. In fact, the “broom” effect disclosed is only for running thin paint brush bristles through paint to create lines and would not be suitable to run through freshly poured concrete, for example, because the bristles would break or bend against concrete. Another problem is that the Dahlstrom system utilizes a UCAT apparatus, which is a device that connects or tethers the aerial vehicle to a mobile base station. The tether is disadvantageous because it may drop down on an unfinished surface, thereby ruining the surface after it is immediately poured and, similarly, the mobile base station would need to be sitting on the unfinished surface, which also would ruin the surface by imprinting imperfections thereon.

Additionally, European Patent No. 3,126,067 to Pardell, the contents of which are herein incorporated by reference in its entirety, discloses a drone and docking station system used to clean smooth surfaces, such as photovoltaic panels or windows. The Pardell cleaning device is essentially a soft duster used to pick up dust or dirt particles on glass or other smooth surfaces. Besides Pardell not mentioning a single instance of finishing a surface, dusters are not designed to effectively “finish” surfaces by moving heavy substances like wet concrete. Applying enough pressure to a delicate surface like a photovoltaic panel or window is subject to break or damage the same, such as by scratching.

There exists, therefore, a need in the art for systems and processes that utilize a UAV to finish a surface without manual labor and within precise and accurate finishing parameters, to eliminate the need to finish surfaces by hand, such as by hovering over the surface with the UAV, extending a finisher at an angle relative to the surface, and sweeping the finisher over the surface at a consistency designed to create a specific texture on the surface. The present invention fulfills these needs and provides further related advantages.

### SUMMARY OF THE INVENTION

In one embodiment, a method for finishing a surface, which may include concrete, utilizing a surface finisher includes the steps of tracking a location of the surface relative to the surface finisher, with a GPS coupled to the surface finisher; flying to the location of the surface from a stored position; imaging a grid on the location of the surface, with a camera coupled to the surface finisher; hovering over the grid at a desired parameter above the surface based on locational information from the camera and GPS; and traversing the grid from at least a first position to at least a second position at a desired speed, with at least one finisher extended to the surface.

Moreover, the traversing step may include the step of moving from at least a first block to at least a second block of the grid; stamping the surface; dispersing air on the surface, via an air nozzle; marking the surface; and measuring a temperature of at least one of the surface, the finisher, or air.

Furthermore, a programming step programs the desired parameter above the surface, including a height and angle above the surface; and programs a desired speed of the surface finisher while traversing the grid. The programming step also includes the steps of communicating the height, angle, and speed parameters between a controller and the surface finisher. The traversing step can be timed to occur at a desired time, where the desired time can occur immediately after the surface is laid or anytime thereafter.

In an embodiment, a surface finishing system process includes the steps of hovering a finisher, coupled to a surface finisher, at a desired height and angle above the surface, and meeting a surface material; leveling the surface material on the surface; smoothing the surface material on the leveled surface; edging a perimeter of the smoothed surface; and texturing the edged surface. Additionally, the steps of leveling the textured surface and smoothing the textured surface, may be included. Moreover, the leveling step may include the steps of removing an excess of surface material from the surface and adding surface material to the surface.

In another embodiment, a system for finishing a surface utilizing a surface finisher, may include a body including a connector attached to a bottom portion thereof; a finisher coupled to the connector, wherein the finisher extends to the surface; a first sensor for determining a distance and an angle of the finisher above the surface, a second sensor for determining a speed of the surface finisher while traversing across a grid imaged on the surface via a camera coupled to the surface finisher, with the finisher extended; and a controller in communication with the first and second sensors for instructing the surface finisher to finish the surface, based on the information determined by the first and second sensors.

In another aspect of the embodiments, the surface finisher may include at least one attachment, selected from a group of a camera, a sensor, a GPS, a propeller guard, a cargo carrier, a spotlight, a speaker, a vacuum, a display screen with a Graphical User Interface (GUI), a projector, a mixing device, a storage container, and a hook.

Moreover, the surface finisher may include at least one finisher selected from a group including a finishing broom, a trowel blade, a handle float, a set of power trowels, a mechanical tube finisher, a vibratory screed finisher, a tining machine, an edger, a cove trowel, a jointer.

Additionally, the surface finisher may create the following textures and patterns on a surface, which may include a steel texture, a fresno texture, a bull float texture, a stone texture, slate, rough stone texture, cobble stamp, brick texture, Roman slate, smooth slate, skin, textured skin, rock salt finish, broom finish, stamped concrete, tine finish, stenciled concrete, exposed aggregate texture, polished concrete, and engravings.

Other features and advantages will become apparent from the following more detailed description, when taken in conjunction with the accompanying drawings, which illustrate, by way of example, the principles of the invention.

### BRIEF DESCRIPTION OF THE DRAWINGS

The accompanying drawings illustrate the surface finisher. In such drawings:

FIG. 1 is a front environmental perspective view of a surface finisher as disclosed herein, hovering above an unfinished surface while imaging a grid on the surface;

FIG. 2A is a front view of one embodiment of the surface finisher, illustrating an internally threaded coupling coupled to a connector.

FIG. 2B is another front view of another embodiment of the surface finisher, illustrating an externally threaded coupling coupled to the connector;

FIG. 2C is another view of one embodiment of the surface finisher, further illustrating the connector coupled to the surface finisher via a coupler;

FIG. 3 is a front view of another embodiment of the surface finisher, further illustrating a chuck coupled with a finishing broom;

FIG. 4A is a front view of another embodiment of the surface finisher, illustrating a ball and socket coupled to an extension including a hinge;

FIG. 4B is another front view of the surface finisher, illustrating a push button release of a broom head of the finishing broom, embodied as the finisher and connected via the extension;

FIG. 5 is a front perspective view of one embodiment of the surface finisher, illustrating the use of one or more finishers;

FIG. 6A is a perspective view of a salt roller for use as one of the finishers illustrated in FIG. 5;

FIG. 6B is a perspective view of a tamper for use as one of the finishers illustrated in FIG. 5;

FIG. 6C is a perspective view of a double roller tamper for use as one of the finishers illustrated in FIG. 5;

FIG. 6D is a perspective view of a material spreader for use as one of the finishers illustrated in FIG. 5;

FIG. 6E is a perspective view of a variable pressure sprayer for use as one of the finishers illustrated in FIG. 5;

FIG. 6F is a perspective view of a mixing station for use as one of the finishers illustrated in FIG. 5;

FIG. 6G is a perspective view of a pump for use as one of the finishers illustrated in FIG. 5;

FIG. 6H is a perspective view of a chemical sprayer for use as one of the finishers illustrated in FIG. 5;

FIG. 7A is a perspective view of a trowel blade for use as one of the finishers illustrated in FIG. 5;

FIG. 7B is a perspective view of a long handle float for use as one of the finishers illustrated in FIG. 5;

FIG. 7C is a perspective view of a power trowel for use as one of the finishers illustrated in FIG. 5;

FIG. 7D is a perspective view of a mechanical tube finisher for use as one of the finishers illustrated in FIG. 5;

FIG. 7E is a perspective view of a vibratory screed finisher for use as one of the finishers illustrated in FIG. 5;

FIG. 7F is a perspective view of a tining machine for use as one of the finishers illustrated in FIG. 5;

FIG. 7G is a perspective view of an edger for use as one of the finishers illustrated in FIG. 5;

FIG. 7H is a perspective view of a cove trowel for use as one of the finishers illustrated in FIG. 5;

FIG. 7I is a perspective view of a jointer for use as one of the finishers illustrated in FIG. 5;

FIG. 7J is a perspective view of a payload release for use as one of the finishers illustrated in FIG. 5;

FIG. 8 is a perspective view of surface textures created by the surface finisher illustrated in FIG. 5, including, a steel texture, a fresno texture, a bull texture, a stone texture, a slate texture, a roughstone texture, a cobble stamp, a brick texture, a Roman slate, a smooth slate, a skin texture, a textured skin, a rock salt finish, a broom finish, a stamped concrete finish, a tine finish, a stenciled concrete finish, an exposed aggregate texture, a polished concrete texture, and engravings;

FIG. 9 is a front perspective view of the surface finisher, illustrating the surface finisher flying from one location away from the surface, to another location above the surface, using the camera to image the grid on the surface, while measuring the distance between the surface finisher and the surface via the GPS, to extend a finisher and fly across the grid at a specified speed to finish the surface;

FIG. 10 is a flowchart illustrating a method utilized by the surface finisher to finish the surface; and

FIG. 11 is a front perspective view illustrating the surface finisher finishing a grass surface.

### DETAILED DESCRIPTION OF THE PREFERRED EMBODIMENTS

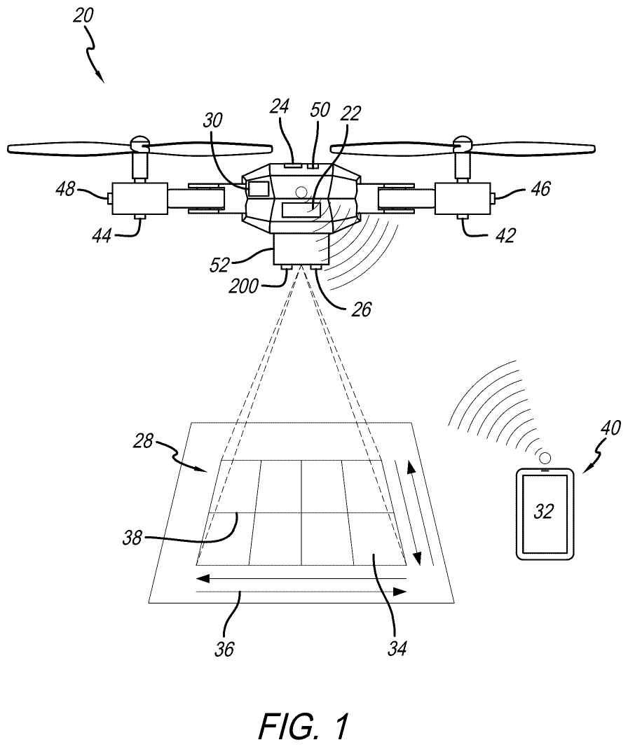

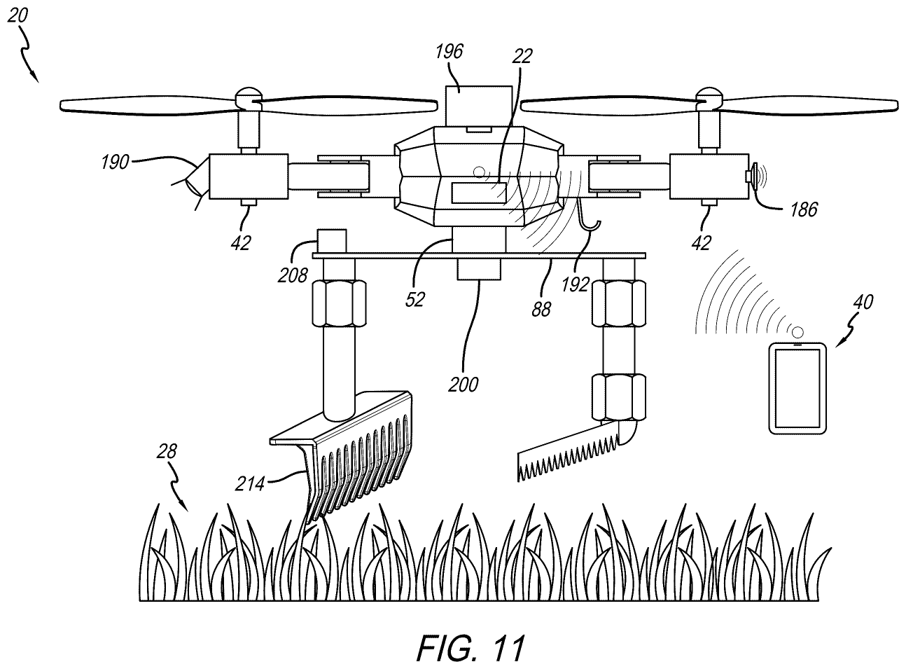

As shown in the exemplary drawings for purposes of illustration, the surface finisher is generally illustrated in FIGS. 1-5, 9, and 11 with respect to reference numeral 20. As such, the term surface finisher 20 as used herein may include any UAV or drone that floats/hovers above any surface, flies, or uses any other similar type of flying method. While blades are depicted, the surface finisher 20 can fly using blades, a bladeless air push method, or any other similar air propulsions. Additionally, the surface finisher 20 may use any number of propulsion methods, including a combination of propellers and jets, and can have any number of rotors, including four, thus embodying a quadcopter. Furthermore, the surface finisher 20 can perform a variety of flying functions such as but not limited to hovering, vertical takeoff and landing, any movement from side to side, a vibrating or shaking motion, and any other movement using the engines, blades, or other propulsion methods of the surface finisher 20 utilizing a wide-range of motions. For example, the rotors of the surface finisher 20 can rotate 360 degrees to fly in all directions, move to any side, and hover at any angle above the surface 28. Also, in some embodiments, the surface finisher 20 may be small enough to perform tasks too small for human access, e.g., in a crawl space, or large enough to carry attachments and utilize finishers too heavy for human use.

While a concrete surface is often referenced herein, the surface finisher 20 can finish any surface 28 that needs finishing, including, but not limited to: cement, pavement, asphalt, gravel, rocks, stones, sand, grass, and other outdoor and indoor surfaces. As such, the term surface 28 herein may include any surface that is able to be finished, including but not limited to the surfaces listed above. Additionally, the term concrete may include the mixture of air, water, sand, gravel, and cement to create concrete. Meanwhile, the term finish and its derivations, as used herein, may include the processes to create desired effects on the surface 28 utilizing specified parameters, including but not limited to the texture, depth, thickness, dimensions, designs, and other parameters referenced herein of the surfaces 28. In addition, the finishing process includes but is not limited to the steps of: an initial leveling of the unfinished surface that includes removing any excess surface material and filling in low material spots. After leveling, a smoothing step occurs to maintain consistency and an edging process creates a defined edge along the surface perimeter, thereby preventing chipping or cracking over time. Next, a texture is typically created. If a floor is desired, then the final finishing stage involves smoothing the surface again to create a smooth level finish and remove any remaining imperfections.

As illustrated in FIG. 1, the surface finisher 20 includes an onboard computer 22 that has a processor that performs a set of operations on information as specified by computer program code. The computer program code is a set of instructions or statements providing instructions for the operation of the processor and/or the computer system to perform specified functions. The code for example, may be written in a computer programming language that is compiled into a native instruction set of the processor. The code may also be written directly using the native instruction set (e.g., machine language). The set of operations include bringing information in from the bus and placing information on the bus. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions. A sequence of operations to be executed by the processor, such as a sequence of operation codes, constitute processor instructions, also called computer system instructions or, simply, computer instructions. Processors may be implemented as mechanical, electrical, magnetic, optical, chemical or quantum components, among others, alone or in combination.

The computer 22 includes a memory coupled to bus. The memory, such as a random-access memory (RAM) or other dynamic storage device, stores information, including processor instructions. Dynamic memory allows information stored therein to be changed by the computer 22. RAM allows a unit of information stored at a location called a memory address to be stored and retrieved independently of information at neighboring addresses. The memory is also used by the processor to store temporary values during execution of processor instructions. The computer 22 also includes a read only memory (ROM) or other static storage device coupled to the bus for storing static information, including instructions, that is not changed by the computer 22. Some memory is composed of volatile storage that loses the information stored thereon when power is lost. Also coupled to the bus is a non-volatile (persistent) storage device for storing information, including instructions, that persists even when the computer 22 is turned off or otherwise loses power. Information, including instructions, is provided to the bus for use by the processor from any external input device, such as a keyboard containing alphanumeric keys operated by a human user, or a sensor. The memory may be housed by the surface finisher 20 and protected from weather or dirty processes that would ruin electronic features. In an embodiment, there is a removeable memory 30 embodied as a thumb drive or other similar memory device that stores data collected by the surface finisher 20. Thus, a user can take the data from the memory 30 of the surface finisher 20 and use it for other purposes, including renderings. The memory may also be connected to a cloud server for wireless cloud computing and storing. For example, a user can instruct the surface finisher 20 to finish the surface 28 from a remote location once the parameters and/or dimensions of the surface 28 to be finished are calculated/imaged and stored in the memory.

Moreover, the surface finisher 20 may send and receive computer program code to execute instructions to finish the surface 28, where the surface finisher 20 may employ cloud computing, computer vision, artificial intelligence, machine learning, and deep learning to assist in finishing the surface 28. In this regard, a GPS 24 of the surface finisher 20 communicates with a camera 26 of the surface finisher 20, and the camera 26 images the surface 28 below the surface finisher 20, where the surface finisher 20 is hovering above.

More specifically, utilizing the camera 26, the surface finisher 20 images a pre-set track, plane, or grid 34 and performs runs 36 over the grid squares 38 at exact coordinates. In that regard, the GPS 24 tracks the exact location and grid coordinates of the surface finisher 20 to determine the exact location, area, and parameters of the surface 28 needing to be finished. A controller 40 communicates with the surface finisher 20 to initiate manual controls or autonomous controls 32 used to finish the surface 28. Moreover, the surface finisher 20 can switch into an autonomous mode 32, where no manual user control is necessary. The GPS 24 and camera 26 scan and read the predetermined grid 34 or similar track layout, so the surface finisher 20 hovers over the surface 28 at a predetermined height and angle, and speed while traversing the surface 28 for finishing. The term imaging as used herein may include the processes of physically projecting on a surface. The imaging may not be shown on a screen to a user and kept housed within the internal circuitry of the surface finisher 20, shown or displayed on a screen, on the surface finisher 20 itself, and/or any other device or computer, including the controller 40.

Additionally, if the GPS 24 determines that the surface finisher 20 reaches the end of the grid 34, the surface finisher 20 will stop its finishing process or running and fly to a predetermined location or hover over a surface at a distance away from the surface. In autonomous mode 32, the surface finisher 20 is capable of performing multiple runs 36. A run 36 herein may include the surface finisher 20 performing steps of a process to finish the surface 28. The surface finisher 20 can be programmed to fly over the surface 28 at a set height and speed, at a certain number of times. For example, the surface finisher 20 can hover over a surface and fly from one distance to another in a back-and-forth manner one hundred times (one hundred runs).

The surface finisher 20 may include a plurality of sensors 42 located at different positions on the surface finisher 20. While the sensors 42 are shown in select areas of the exemplary illustrations, the sensors 42 can be placed anywhere on the surface finisher 20, depending on the size of the surface finisher 20. More specifically, the sensors 42 may include weight-determining sensors 44 to determine the weight on an attachment and finisher. For example, the weight determining sensor 44 determines the amount of any material, such as concrete, remaining on a finisher. Other sensors 42 are proximity sensors 46, that determine if there is an object too close to the surface finisher 20. The proximity sensors 46 determine the proximity of an object and send instructions to the surface finisher 20 to act accordingly. In this regard, the GPS 24 and camera 26 are used to image the distance between the surface finisher 20 and the potential obstruction to assist it in turning away. For example, if the proximity sensor 46 of the surface finisher 20 calculates that it is too close to a wall, then it turns around or stops in place. The proximity sensors 46 also determines how close the surface finisher 20 should get to the surface to perform a desired finishing action. The specified height is input via software according to any desired height which informs the surface finisher 20 of the proper height to perform a run 36 corresponding to the surface 28 to finish. The surface finisher 20 can also be programmed via software to hover at a predetermined amount of time after a surface is ready and/or poured. For example, after concrete is poured, the surface finisher 20 can immediately perform the run 36 to finish the concrete or it can wait a predetermined amount of time to finish the surface 28. Similarly, thermal imaging sensors 48 are employed to determine a desired imaging of a building, wall, the surface 28, or other construction need.

Additionally, the surface finisher 20 may include weather sensors 50 that sense weather and other data such as temperature, wind, humidity, and precipitation. The data collected from the weather sensors 50 are communicated to the surface finisher 20, where it performs a corresponding action, such as stopping the finishing process until more opportune weather, like humidity or wind if outside, and resuming finishing the surface 28 when the weather is more ideal. For example, if in an outdoor setting, concrete is poured but immediately thereafter there is wind, the surface finisher 20 will wait until the wind stops to perform the run 36 or even perform the run 36 in conditions that manual laborers are unable to continue working in. When the weather sensor 50 measures a temperature, which can be embodied as a temperature gauge, or thermometer; the weather sensor 50 determines the temperature of the ambient air, also the temperature of the surface 28 below the surface finisher 20, and the temperature of the attachments and finishers. In one embodiment, the weather sensor 50 on the surface finisher 20 determines that the temperature of a finishing broom is too hot and thereby instructs the surface finisher 20 to leave the area to cool down and return when the temperature is lower. In another example, the surface finisher 20, via weather sensors 50, can sense weather, such as wind, humidity, sunlight, or if in an outdoor setting, if rain is forecasted, and create a schedule of performing runs 36—stopping and starting to avoid bad weather or imperfect finishing conditions.

In an embodiment, the surface finisher 20 is controlled by a controller 40. The controller 40 can be a remote controller device used by a user and embodied via an iPad, iPhone, any smart device, physical controller, remote, or any other similar remote controlling device. In one embodiment, the controller 40 is controlled via a skilled worker/user, which in turn controls the surface finisher 20 to finish a surface via a manual mode. Software may also be installed on the controller 40 to control the surface finisher 20 and its functions, features, attachments, connectors 52, and finishers 70.

Furthermore, the surface finisher 20 accepts a plurality of attachments and finishers 70 via a connector 52. The term accept(ing)/connect(ing) as used herein may include receiving one end of an attachment and/or finisher while also enabling said device, including assembling any electrical connections and wiring and controlling the device's functions and movements. For example, connecting the finisher 70 that is embodied as a power trowel 140 would also refer to enabling the power trowel 140 as well, which would include creating an electrical connection to power the power trowel 140, among powering the motor.

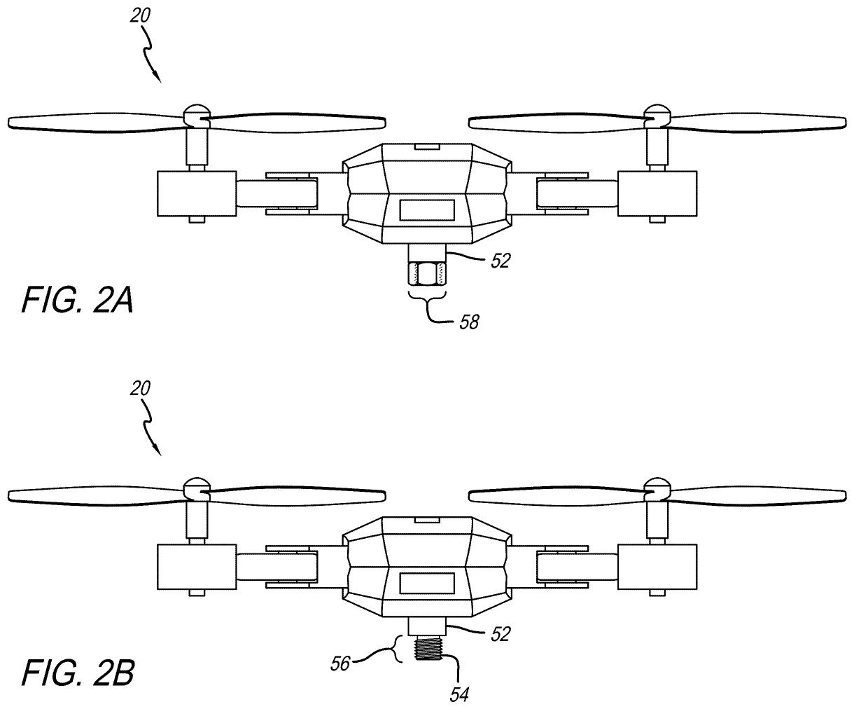

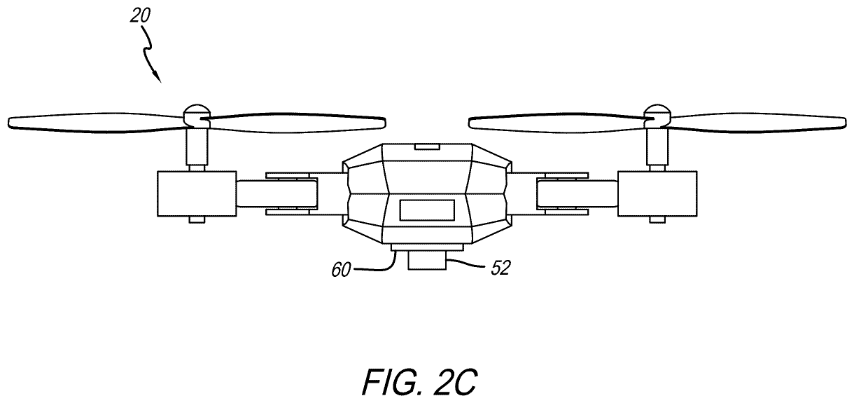

As shown in FIGS. 2A, 2B, and 2C, the surface finisher 20 has the connector 52 that accepts a plurality of attachments and finishers while being embodied in different forms. The connector 52 is able to have multiple embodiments and can accept a plurality of various attachments and finishers 70, independent of how each item is made. Thus, the surface finisher does not mandate specifically made attachments or finishers. Because the connector 52 is not limited to one embodiment and there can be many or one single connector 52, the surface finisher 20 is able to accomplish many tasks, specifically in the construction and lawn care industry for finishing surfaces. In an embodiment, the connector 52 has attachable parts to act as the connector 52. For example, the connector 52 has an attachable externally threaded coupling 56, where attachments screw onto it, and an attachable internally threaded coupling 58, where attachments are inserted. The connector 52 also has threads 54 to accept different attachments. In regards to the externally threaded coupling 56 and internally threaded coupling 58 may be one uniform piece with the connector 52 or removably attached to the connector 52 by a coupler 60, including a magnet, a screw holding the connector 52 and attachment in place, a nut and bolt, an electromagnet, or another similar method.

Moreover, the connector 52 is not limited to specific attachments, because the connector 52 can also be removable to adhere to specific attachments. For example, a coupler 60 can be installed on the bottom portion of the surface finisher 20 to employ the externally threaded coupling 56 and replace it with an internally threaded coupling 58. In other embodiments, the connector 52 is not removable and in other embodiments, the connector 52 is removable via other systems such as a coupler 60, including but not limited to a nut-and-bolt, a screw, magnet, electro-magnet, screw, or any other methods of attachments that creates removability. Every connector 52 referenced herein has the option to be removable via a coupler 60, including a magnet, an electro-magnet, screw, nut and bolt, or other systems to create a removeable device. In addition, the surface finisher 20 may be operated without the connector 52. While the connector 52 is depicted as a separate piece, it may be one uniform piece, for example, one extension 76 and one connector 52 combination, or even the connector 52 is one part of a finisher 70. Stated differently, the connector 52 can be embodied differently depending on the task that the surface finisher 20 accomplishes.

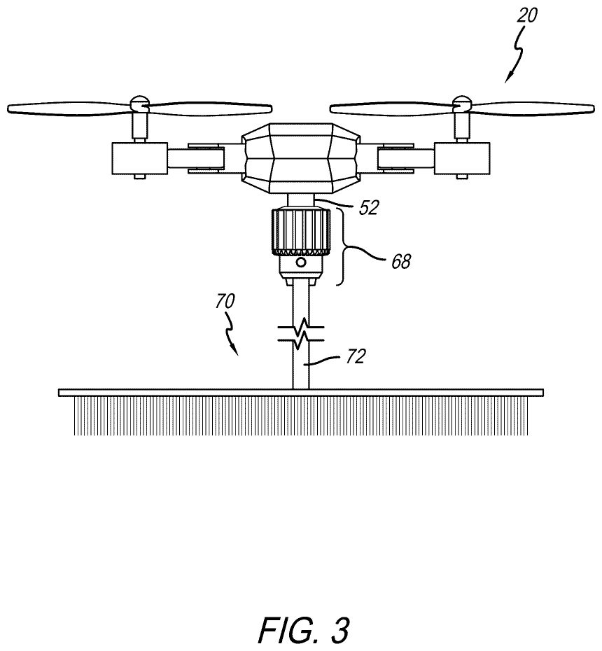

As shown in FIG. 3, the connector 52 can receive an attachable chuck 68, where the chuck 68 is spread and the teeth widened enough to slide an attachment/finisher 70 into the teeth. The chuck 68 is then tightened to firmly secure any attachment. For example, the chuck 68 can grasp the end of a finishing broom 72 in between the chuck 68 and perform the run 36 over a surface. The chuck 68 can accept any elongated attachment such as the extension 76 and the finisher 70.

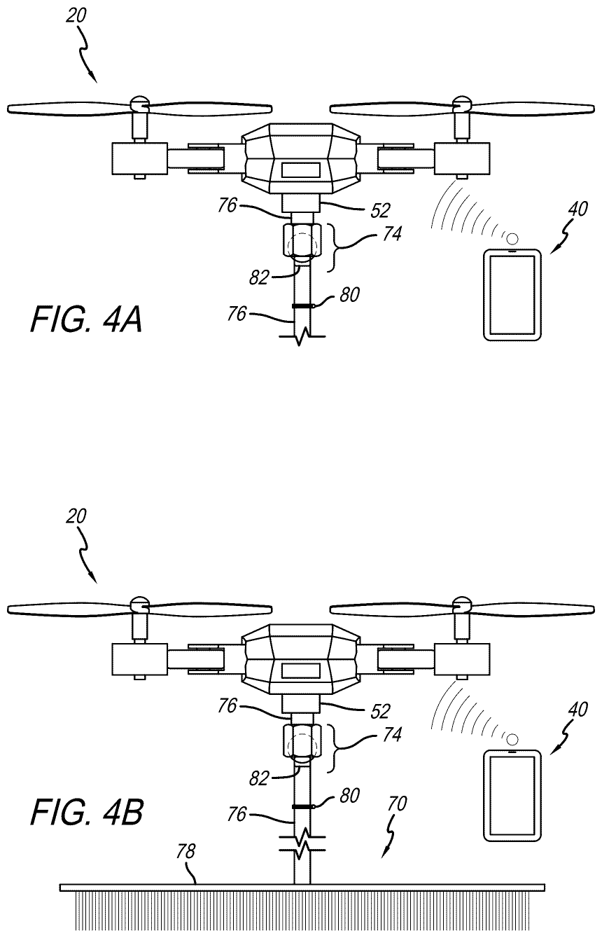

As shown in FIGS. 4A and 4B, the connector 52 can also receive an attachable socket where a ball is accepted to create 360 degrees of rotation, thereby creating a ball and socket 74. The ball and socket 74 can be embodied as one of a ball and socket 74 or can only be a socket, where the extension 76 has a ball to fit into the socket. For the ball and socket 74 embodiment of the connector 52, a user can program the surface finisher 20 to, at any angle and at any height above the surface 28, to perform a desired action on the surface 28.

In another embodiment, illustrated in FIG. 4B, the connector 52 features the ball and socket 74, where the finisher 70 has an extension 76 and a disposable broom head 78. The broom head 78 can be disposable and ejected either manually or automatically once the weight-determining sensor 44 determines that the weight on the broom head 78 is passed a certain threshold level. The threshold level can be predetermined by the software on the surface finisher 20 and/or on the controller 40 and input by the user. The broom head 78 may be ejected via a push button release 80, similar to a micro-pipette tip ejection system. While the broom head 78 is shown as a broom, it can be a brush or any other similar device for finishing the surface 28.

Additionally, the connector 52 has the extension 76 that meets the connector 52 located on the bottom of the surface finisher 20. The extension 76 is extendable and can be modular to create a desired length. The extension 76 can also fold at a hinge 82 on the extension 76 for compact storage. The extension 76 is preferably made of a weather resistant and sturdy material like metal, but it can also be made of other materials such as wood, plastic, metalloids, synthetics, or other similar materials. The extension can be removable or not; when not removable, it is flush against the connector 52. The extension 76 can also be embodied as any standard attachment handle, like a broom, brush, trowel, or any other tool handle. The extension, in that embodiment of a standard attachment handle, would meet the connector 52, where the connector 52 would perform a desired function with the attachment. The extension 76 can also have a ball located at one end opposite the finisher 70 end that is accepted into the ball and socket 74 as the connector 52.

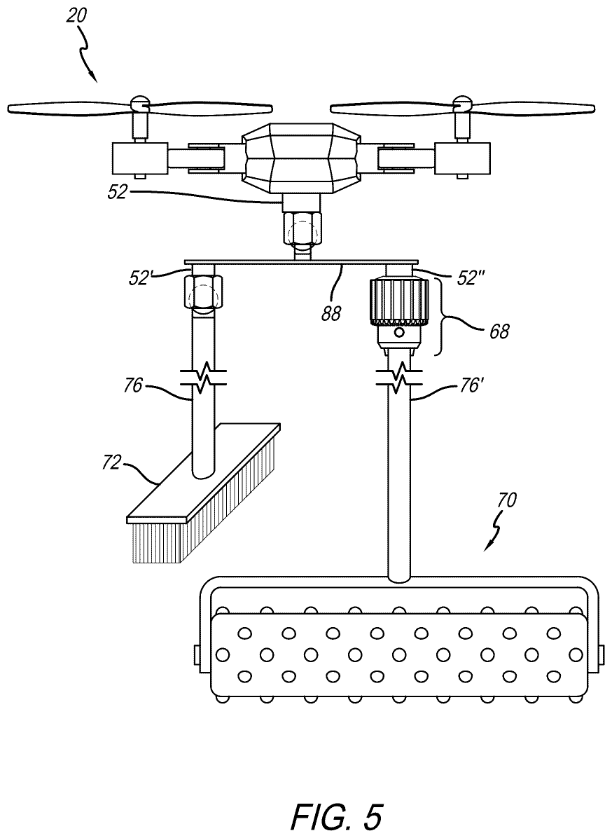

As shown in FIG. 5, there can be more than one connector 52, for example, at least a second connector 52′, a third connector 52″, and there can be multiple extensions 76, for example, at least a second extension 76′, that accompany the at least second connector 52′. There may also be a combination of connectors 52 embodied as the chuck 68, for example, and the second connector 52′ embodied as the ball and socket 74. The first extension 76 and the second extension 76′ are connected via a support 88 that enables multiple connectors and extensions. For example, there may include the second connector 52′, but there can be more connectors 52, depending on the size of the surface finisher 20. The support 88 may attach to the connectors by a coupler 60, including a magnet, a screw holding the connector 52 and attachment in place, a nut and bolt, an electromagnet, and the like. In one embodiment there are four connectors (52, 52′, 52″, 52′″) coupled to each rotor of the quadcopter surface finisher 20 embodiment. The same is true for the multiple extensions 76′, which correspond to the multiple connectors 52. Alternatively, for one connector 52, the support 88 accepts at least one or two extensions 76 instead of multiple connectors. Either on the first connector 52 or second connector 52′, or the pluralities of connectors, the finisher 70 is attached, thereby creating two extensions 76′. As such, the finisher 70 can be a finishing broom 72 that has steel bristles to create various textures and in various directions. In addition, the finisher 70 may have its own extension, like a broom pole that is attached to the broom finishing head 78.

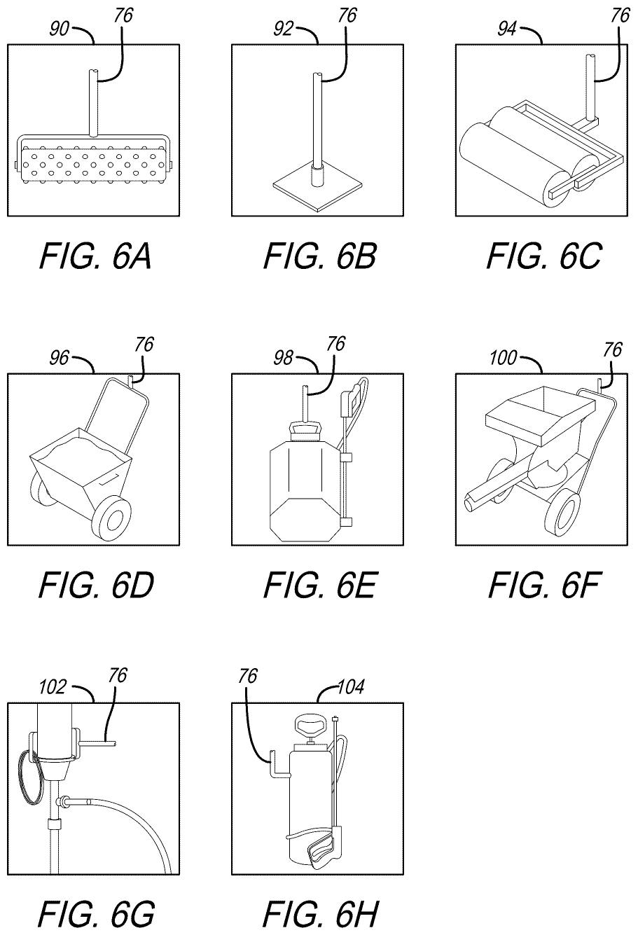

As shown in FIGS. 6A-6H, the attachments and finishers 70 may be used specifically to assist in finishing the surface 28 and include, but not necessarily be limited to, a salt roller 90, a tamper 92, a double roller tamper 94, a material spreader 96, a variable pressure sprayer 98, a mixing station 100, a pump 102, and a chemical sprayer 104. As illustrated, each attachment/finisher has an extension 76 that attaches to the surface finisher 20, shown via the same extension 76, via the connector 52.

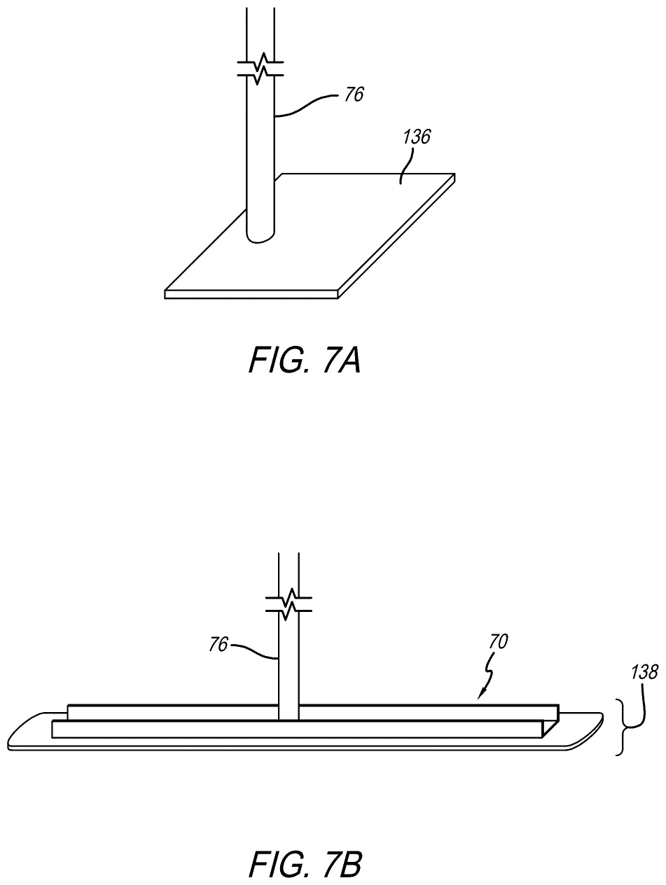

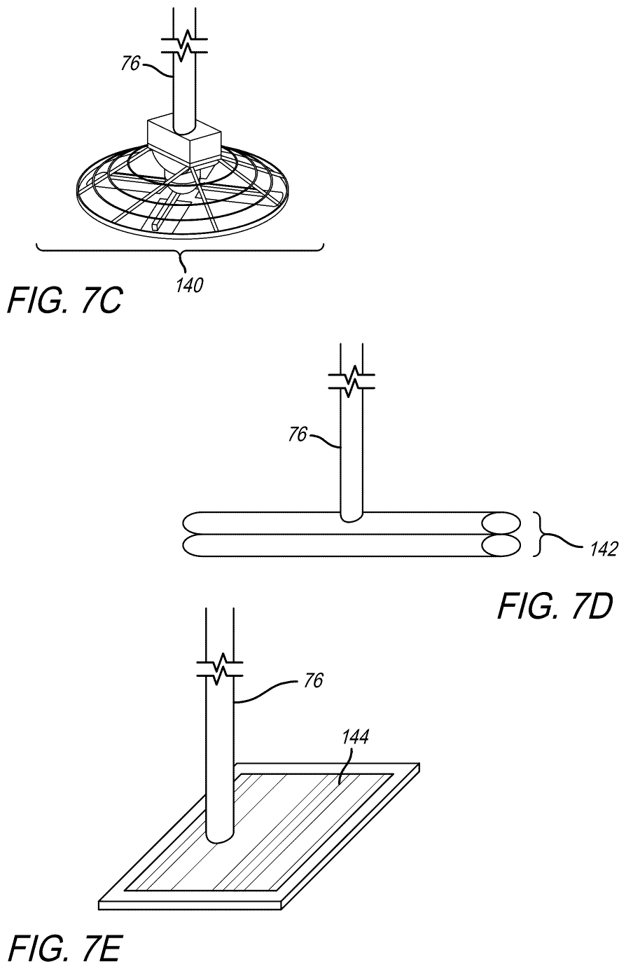

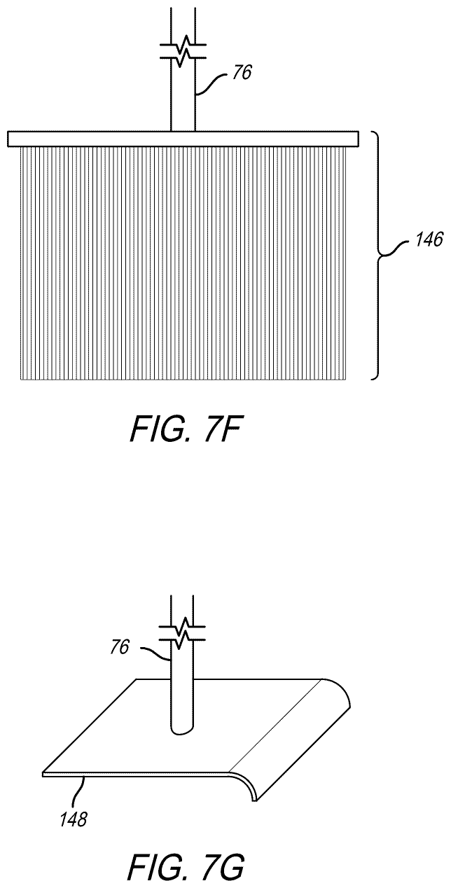

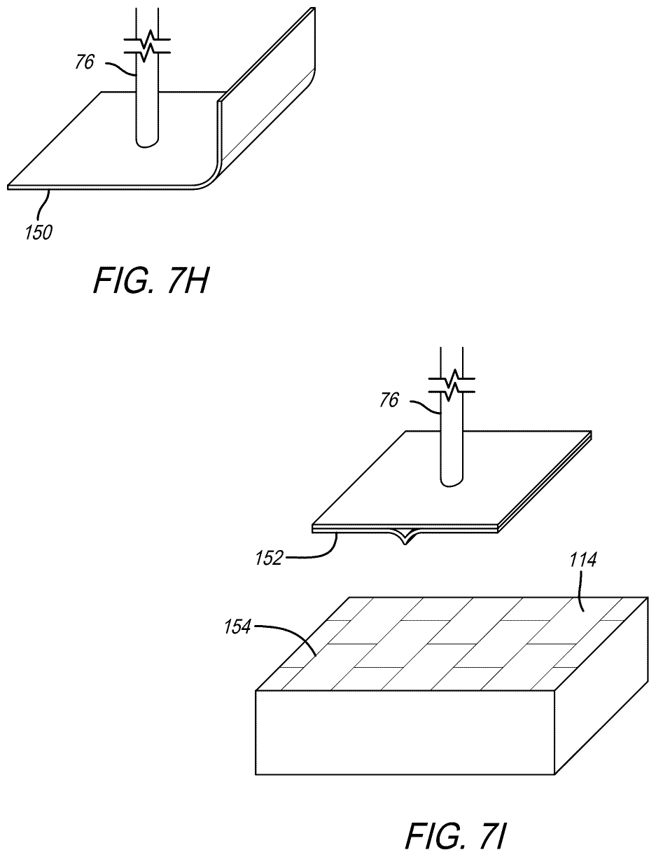

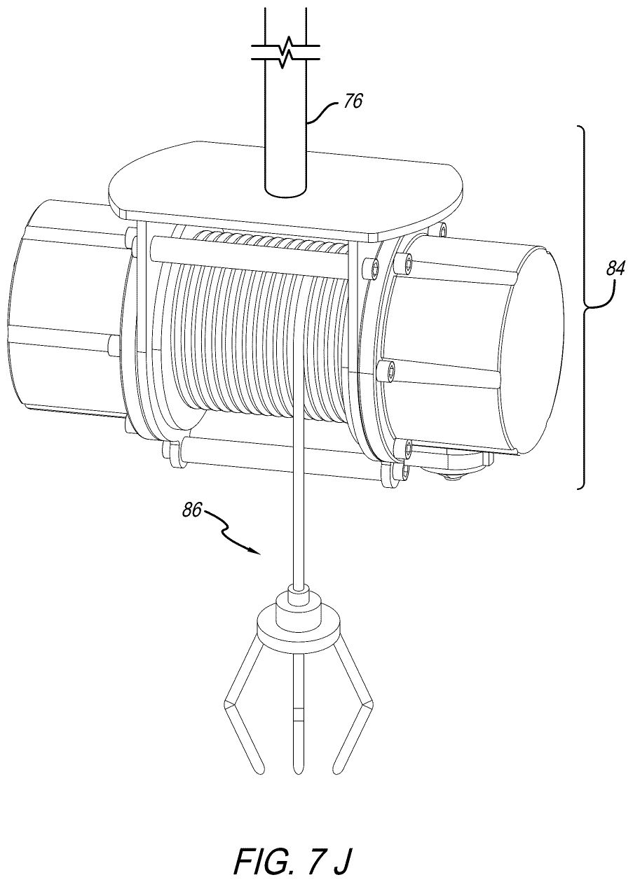

As shown in FIGS. 7A-7J, the surface finisher 20 has the finisher 70, which may be any device used to finish a surface (e.g., freshly poured concrete). Finishing a surface may refer to any process to modify a surface and obtain desired effects, as discussed in detail herein. Also, the finisher 70 can utilize vibration methods to assist in finishing the surface 28. For example, the surface finisher 20 can create a shaking or the vibration can be from the finisher 70.

The finisher 70 can be embodied in many forms as illustrated in FIGS. 7A-7J. For example, FIG. 7A depicts a trowel blade 136, which is made of wood, plastic, steel, or any other similar material and provides a hard polished finish on the surface of the concrete while eliminating the risk of leaving burn marks. Additionally, as shown in FIG. 7B, the finisher 70 can be embodied as a bull float, long handle float, edge float, or any other similar float 138, as noted in the industry, which can be between seven inches wide and up to five feet in length. The long handle float 138, for example, is made of high-quality tempered flexible steel and a rounded end to prevent marking and gouging while creating a smooth surface. As illustrated in FIG. 7C, the finisher 70 can also be embodied as a set of power trowels 140 that attach to a motor that rotate at a high speed on the concrete surface designed to give the concrete a smooth finish. The finisher 70 can be embodied as a mechanical tube finisher 142 with single or multiple rotating strike-off/finish tubes setting, as shown in FIG. 7D. The tubes are at least two feet longer than the required width of the concrete surface to be finished and are typically used in pavement finishing. The finisher 70 can also be embodied as a vibratory screed finisher 144 with a truss frame and a minimum base width of one foot, as depicted in FIG. 7E. It is fixed with mechanically driven eccentric weights or with auxiliary driven pneumatic vibrators that create a vibratory action on the surface 28.

As shown in FIG. 7F, the finisher 70 can be embodied as a tining machine 146 that forms uniform transverse grooves on the surface. The tining machine 146 uses a texturizing comb with steel tines spaced apart. The grooves made on the surface provide skid resistance and prevent hydroplaning on surfaces such as concrete and pavement. Also, FIG. 7G illustrates that the finisher 70 may be embodied as an edger 124, which creates a rounded edge along the perimeter to help the surface, such as concrete, resist chipping and spalling damage. For example, on patios, sidewalks, curbs, and driveways, the edger 124 produces a tight, clean-looking edge that is more resistant to chipping. The finisher 70 is also embodied as a cove trowel 150, shown in FIG. 7H, that creates a cove finish, also known as a mag swirl finish. The cove trowel 150 may have a fine edge on two sides and saw-shaped edges on two other sides, which make various patterns on a concrete surface.

As illustrated in FIG. 7I, the surface finisher 20 also has the finisher 70 that is embodied as a jointer 152, to make a joint 154 on a surface. The jointer 152 creates a joint 154 at a specified depth, typically ¼ of the depth of the surface. The jointer 152 though can create a joint at any depth. In one embodiment, the jointer 152 makes a joint 154 on a slab of concrete at a specified depth corresponding to the total depth, width, and/or length of the surface 28. The joints created by the jointer 152 prevent surfaces from cracking over time and increases the longevity of the surface 28 by increasing its resistance to weather conditions.

As shown in FIG. 7J, and as another attachment and finisher 70 to the surface finisher 20 and/or embodied as the connector 52, is a payload release 84 that enables the surface finisher 20 to carry and drop objects. For example, the payload release 84 grabs an object, such as a rock and releases it at another desired location before, during, or after finishing the surface 28. Moreover, the payload release 84 may include a winch cable 86 to drop a payload and pick up from distances above the surface 28. For other construction applications, the surface finisher 20 can accept via the payload release 84 a sprayer, squeegee, sponge, any window cleaner, or other similar device used for washing windows. In another application for overhead cable installation, the surface finisher 20 uses the payload release 84 to pick up and install overhead cables that pose dangers to human lives. In a similar embodiment, the payload release 84 of the surface finisher 20 can replace a light bulb that is at an unsafe height for humans.

Further, the surface finisher 20 can accept a plurality of other finishing tools, including but not being limited to a broom, a bull float, a tine, a jointer, an edge float, a trowel, a squeegee 156, a cure 164, a sealer sprayer 166, and a dry shake hardener 168.

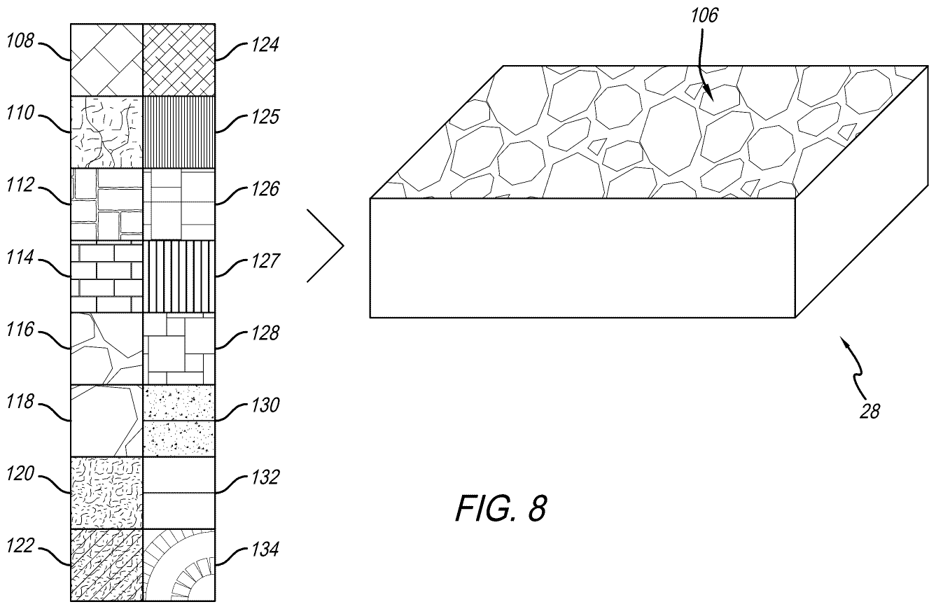

As illustrated in FIG. 8, the attachments and finishers 70 may be generally used to create various textures and patterns on a surface, which include, but are not limited, to a stone texture, including roughstone 106; slate 108; skin, including textured skin 110; cobble stamp 112; brick texture 114; Roman slate, including smooth slate 116; steel 118; fresno 120; bull 122; rock salt finish 124; broom finish 125; stamped concrete 126; tine finish 127; stenciled concrete 128; exposed aggregate texture 130; polished concrete 132; and engravings 134.

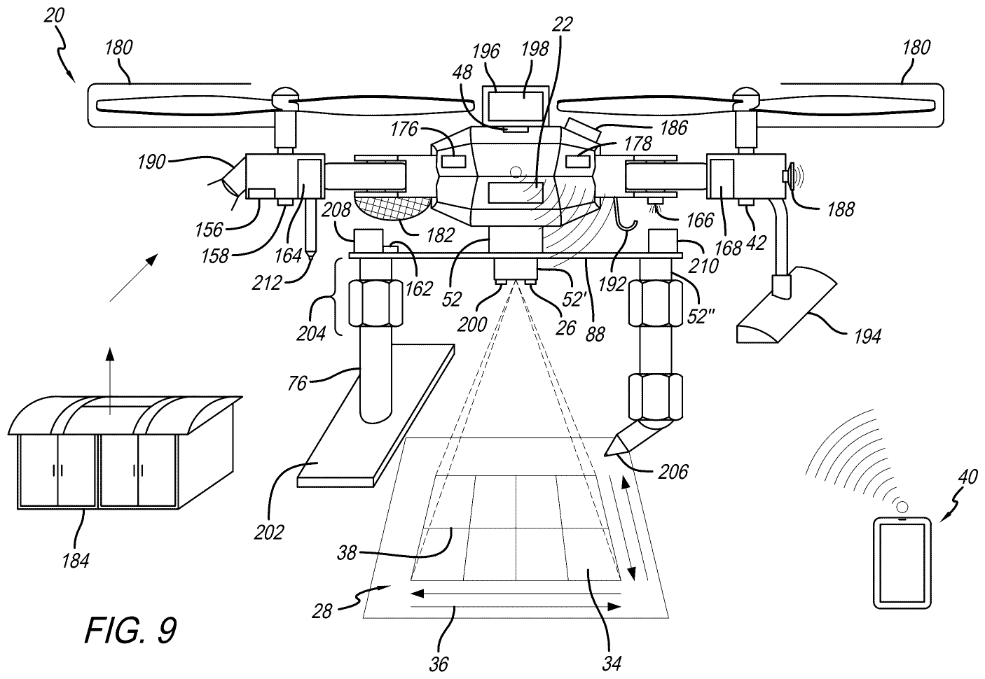

As shown in FIG. 9, the surface finisher 20 features a plurality of attachments, including cameras 26, sensors 42, GPSs 24, propeller guards 180, and cargo carriers 182. The camera 26 allows the surface finisher 20 to align with an area of a surface that needs to be finished and enables a user to view the work being completed on the surface. A user can view what the camera 26 is imaging via the controller 40, which can be embodied as an iPad connected to a network. The camera 26 may include any imaging device, such as a video camera that can record a video stream and store it in the memory, such as the removeable memory 30.

Other attachments include speakers 188, spotlights 190, and hooks 192. The speakers 188 can play any desired announcement, which can be sent from the controller 40, similar to an intercom system or it can play music. The surface finisher 20 may include one or more spotlights 190 that shine to create a safe working space for workers to work at night or in the dark. The hooks 192 are used to latch onto a desired object or wall and/or to pull an object. For example, via a hook 192, the surface finisher 20 can pull an object, like a rake, prongs, tines, or a broom across a surface. Another attachment on the surface finisher 20 includes a vacuum 194 to clean up any waste. The vacuum 194, in an embodiment, can suck up waste from a gutter or other high-up surface that poses a risk to human lives.

The surface finisher 20 may also employ a display screen 196 on a portion of the surface finisher 20. The display screen 196 provides a user with a Graphical User Interface (“GUI”) 198 to use the software and program the surface finisher to perform a desired action. In addition, the surface finisher may also employ a projector 200 to project downward onto a surface, its grid 34 to show a user the exact dimensions of the surface area to be finished.

Furthermore, the surface finisher 20 has a stamper 202 to create a stamp on the surface 28. The stamp may include any marking, design, or imprint on a surface. The extension 76 has a pneumatic arm 204 to create a pressurized stamp on the surface. The increased pressure from the pneumatic arm 204 may create a permanent stamp on the surface 28. For example, on freshly poured concrete, the stamper 202 may create a stamp based on a design. In another scenario, the stamper 202 may create a design after the surface has cooled. Another attachment is an air nozzle 206. The air nozzle 206 is used to blow away waste products and aid in the finishing process by cooling hot-temperature materials and surfaces 28. Moreover, the air nozzle 206 is used to cool down a surface if the temperature is too hot to be finished, which is sensed from sensors 50, determining the temperature of the surface 28. The air nozzle 206 also can be used to create specified designs on the surface 28 by blowing air in patterns.

In addition, the surface finisher 20 features a mixer 208. The mixer 208 uses a container 162 that stores fluids and dyes and then mixes such liquids. The mixer 208 adds any color into the container 162, where the surface finisher 20 will dump, place, or spray the liquid on the surface 28. Additionally, the surface finisher 20 has the container 162 for holding utensils, attachments, equipment, or anything needed to finish a surface. The surface finisher 20 also has a marker 212, such as a spray paint canister, paintbrush, or any other marker. The marker 212 allows the surface finisher 20 to make any visual markings on a surface. For example, the surface finisher 20 can use its marker 212 to spray paint an “X” across a desired spot for concrete to be poured, once poured, the surface finisher 20 flies over to the surface 28, and starts the finishing process.

In an embodiment, the surface finisher 20 has a docking station 184 for charging and storage for future use. The docking station 184 may be positioned at a location distal from the surface 28 so as not to interfere with the finishing process. The surface finisher 20 flies out of the docking station 184, from its stored position, upon receiving a command/instruction; tracks the location of the surface 28; and flies towards the surface 28, until hovering above the surface 28 at the first position. In another embodiment, the surface finisher 20 has a battery pack 186 which is battery powered and/or powered by renewable energy sources, including but not limited to solar, wind, or water. For example, the surface finisher 20 may have solar panels 158 attached to an exterior to harness the power from the sun and provide power via solar energy. Additionally, the surface finisher 20 may include a gesture control module 176 that enables users to control movements of the surface finisher 20 by waiving their hand or making specific gestures. By recognizing hand gestures, the surface finisher 20 can perform various commands, such as taking off, landing, or capturing photos and videos. The surface finisher 20 may also include an object tracking module 178 that can lock onto and follow a designated subject, keeping it in frame while the surface finisher 20 is in motion. For example, the surface finisher 20 may need to capture a photograph of the surface 28 from many different heights and angles.

All aforementioned attachments are attachable to the surface finisher 20 and may be placed in various locations, not depicted in the exemplary figures. For example, the attachments can screw on/off, are replaceable/disposable, or attachable via various methods.

FIG. 9 illustrates a method 900 for finishing the surface 28 utilizing the surface finisher 20 disclosed herein. Specifically, the first step is to image a grid 34 on the surface 28 via the surface finisher 20 as part of a step (902). In this regard, the surface finisher 20 flies from one location away from the surface 28, to another location above the surface 28, utilizing the GPS 24 of the surface finisher 22 which communicates with the camera 26 and transmits coordinates from what the camera views to the surface finisher 20 to track the location at all times. In step (904), the surface finisher 20 then, while hovering over the surface, images the grid 34 at a location above the surface 28. Once the camera images the grid on the surface at a location, the surface finisher 20 receives the GPS coordinates and determines a distance between the surface 28 and surface finisher 20. The surface finisher 20 can automatically, without user input, fly to a predetermined height and angle above the surface 28 to finish it at a second position and also fly to the same parameters via user control. The surface finisher 20 extends at least one finisher 70 towards the surface 28 to meet the surface 28, while at the first position as part of step (906). Once the finisher 70 is extended and reaching a surface 28, the surface finisher 20 traverses the grid 34 from the first position to the second position at a desired speed (908). Further, the traversing step (908) includes moving from at least a first grid square 38 to a second grid square 38 until the entire grid or grid portion is traversed, as desired, thereby completing a run 36. The run 36 may include the processes of moving across the grid 34 from one square 38 to another square 38. Once each square 38 is traversed, the surface 28 should be finished.

Moreover, the traversing step includes the steps of finishing the surface 28, which include: a leveling step (910) that includes removing any excess surface material and filling in low material spots. After the surface is leveled, a smoothing step (912) occurs to maintain a consistent texture and smoothness of the surface. Then, an edging step (914) can be performed, which creates a defined edge along a surface's perimeter to prevent chipping or cracking over time. Once edged, the surface is textured (916), if desired, to create any one of the textures 106, 108, 110, 112, 114, 116, 118, 120, 122, 124, 125, 126, 127, 128, 130, 132, and 134 via the finisher 70, and as shown in FIG. 6. In addition, if a floor is desired to be laid, then a second smoothing step (918) occurs, where the surface 28 is smoothed to create a level finish and remove any remaining imperfections. Furthermore, if desired, the surface 28 can be stamped (920) with a specified design, marking, or the like. Also, air can be dispersed on the surface 28 via an air nozzle 206 as part of a step (922) and the marker 212 may be used to mark the surface as part of step (924). Also, the surface finisher 20 may measure the temperature of the surface (926). Further, the user may program the desired parameters and desired speed of the surface finisher 20, including the height and angle above the surface (928). After it is programmed, the controller 40 communicates the desired parameters and desired speed to the surface finisher 20 as part of a step (930). Thus, the timing of the traversing step above may occur at any desired time after the unfinished surface is laid in step (932). At this point, the method is thus complete (934).

Any of the steps listed above can be performed in any order according to the user's expertise and each step can be optionally performed. Additionally, each step can be performed via any attachment or finisher 70 of the surface finisher 20 disclosed and shown herein and each step can be performed automatically and/or manually.

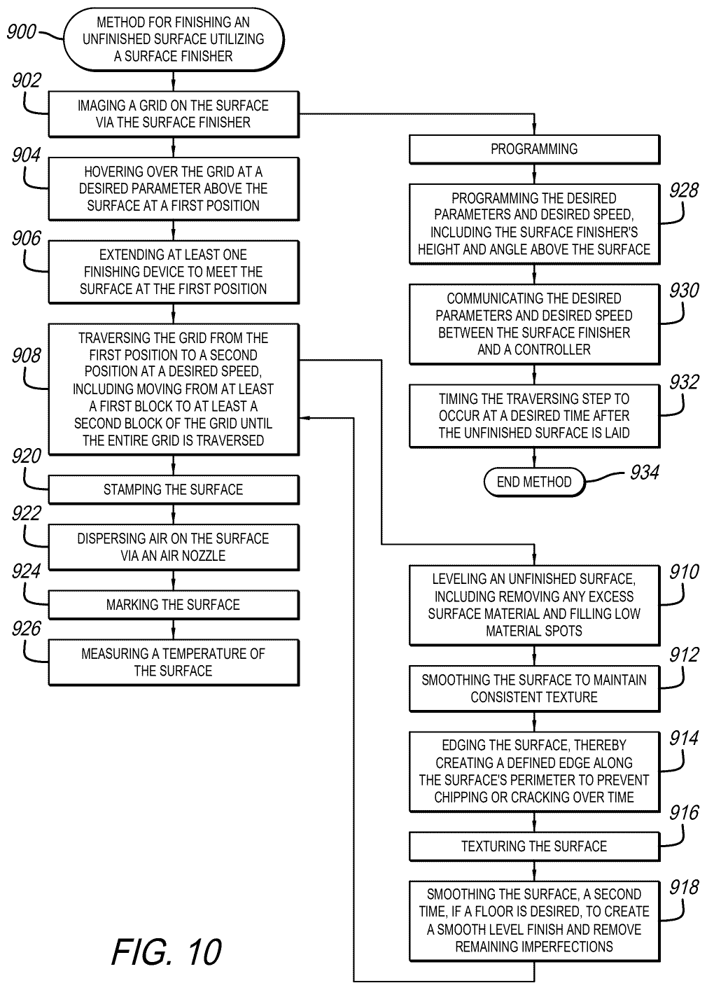

In an embodiment and as shown in FIG. 10, the surface finisher 20 has numerous attachments that are attached to the connector 52 for providing lawn care. The connector 52 may accept a plurality of lawn care equipment 214 including, but not limited to a rake, broom, leaf blower, plow, shovel, weed pullers, tillers, aerators, weed whackers, and other similar yard equipment. Additionally, the attachments may include a saw (e.g., a motorized saw, chain saw, or the like), a hedge trimmer, or any other similar blade device used to trim hedges and cut grass or other trimming and cutting outdoor needs. The surface finisher 20 can fly over hedges or fly into trees to trim what is desired.

The surface finisher 20 can vary in size, shape, and arrangement of elements. For example, the air propulsion technology of the surface finisher 20 can be located on the sides or on top of the surface finisher 20 similar to that of a helicopter, or there can be multiple blades, similar to that of a quadcopter. Moreover, the finishers 70, the connectors 52, and the extensions 76 can be located at different positions on the surface finisher 20, as needed to finish the surface 28. Furthermore, for large scale surfaces 28 to finish, the surface finisher 20 can carry a cargo of 420 lbs. or more, as needed. The surface finisher 20 can also be 750 ft. in length, or larger, if needed.

Although several embodiments have been described in detail for purposes of illustration, various modifications may be made without departing from the scope and spirit of the invention. Accordingly, the invention is not to be limited, except as by the appended claims.

What is claimed is:

1. A method for finishing a surface utilizing a surface finisher, comprising the steps of:
defining an area of the surface to finish;
hovering over the area; and
finishing the surface while hovering over the area with at least one finisher extended to the surface.

2. The method of claim 1, including the step of imaging a grid on the surface.

3. The method of claim 1, wherein the finishing step includes the step of traversing the grid from at least a first block to at least a second block of the grid at a desired speed.

4. The method of claim 1, wherein the hovering step includes hovering at a desired parameter above the surface.

5. The method of claim 4, including the step of programming the desired parameter, wherein the desired parameter includes a height above the surface, an angle above the surface, or a grid traversing speed.

6. The method of claim 5, wherein the programming step includes the step of communicating the height, the angle, and the grid traversing speed between a controller and the surface finisher.

7. The method of claim 5, wherein the programming step includes the step of timing the finishing step to occur at a desired time.

8. The method of claim 1, wherein the surface comprises concrete.

9. The method of claim 1, including the step of stamping the surface.

10. The method of claim 1, including the step of dispersing air on the surface via an air nozzle.

11. The method of claim 1, including the step of marking the surface.

12. The method of claim 1, including the step of measuring a temperature of at least one of the surface, the finisher, or air.

13. The method of claim 1, wherein the surface finisher includes at least one attachment selected from the group consisting of a camera, a sensor, a GPS, a propeller guard, a cargo carrier, a spotlight, a speaker, a vacuum, a display screen with a Graphical User Interface (GUI), a projector, a mixer, a storage container, and a hook.

14. The method of claim 1, wherein the at least one finisher is selected from the group consisting of a finishing broom, a trowel blade, a handle float, a set of power trowels, a mechanical tube finisher, a vibratory screed finisher, a tining machine, an edger, a cove trowel, and a jointer.

15. A surface finishing system process, comprising the steps of:
hovering a finisher coupled to a surface finisher at a desired height and a desired angle above a surface leveling a surface material on the surface with the surface finisher;
smoothing the surface material on the leveled surface;
edging a perimeter of the smoothed surface; and
texturing the edged perimeter.

16. The process of claim 15, wherein the leveling step includes the step of removing an excess of the surface material from the surface.

17. The process of claim 15, wherein the leveling step includes the step of adding surface material to the surface.

18. The process of claim 15, wherein the texturing step includes creating a texture selected from a group consisting of a stone texture, a slate texture, a cobble stamp, a brick texture, a Roman slate texture, a skin texture, a rock salt finish, a broom finish, a stamped concrete texture, a tine finish, a steel finish, a fresno finish, a bull finish, a stenciled concrete texture, an exposed aggregate texture, a polished concrete texture, and an engraving.

19. A system for finishing a surface utilizing a surface finisher, comprising:
a body including a connector attached to a bottom portion;
a finisher coupled to the connector, wherein the finisher extends to the surface;
a first sensor for determining a distance and an angle of the finisher above the surface,
a second sensor for determining a speed of the surface finisher while traversing across a grid imaged on the surface; and
a controller in communication with the first and second sensors for instructing the surface finisher to finish the surface based on the information determined by the first and second sensors.
